(19) United States
(12) Patent Application Publication
(10) Pub. No.: US 2023/0398626 A1
(43) Pub. Date: Dec. 14, 2023

(54) LASER PROCESSING DEVICE

(71) Applicant: Panasonic Intellectual Property Management Co., Ltd., Osaka (JP)

(72) Inventors: MITUHIRO YOSINAGA, Osaka (JP); MIZUHO ABE, Osaka (JP)

(21) Appl. No.: 18/303,606

(22) Filed: Apr. 20, 2023

(30) Foreign Application Priority Data
Jun. 10, 2022 (JP) 2022-094150

(51) Int. Cl. B23K 26/03; B23K 26/067; B23K 26/06; G01B 11/22; H02K 15/00

(52) U.S. Cl. CPC B23K 26/032; B23K 26/067; B23K 26/0643; B23K 26/0648; G01B 11/22; H02K 15/0081

(57) ABSTRACT

A laser processing device includes a first branching unit that branches laser light into first laser light emitted to a first processing point and second laser light emitted to a second processing point, an optical interferometer that emits measurement light having a wavelength different from a wavelength of the laser light, and generates an optical interference signal based on the measurement light, a lens that condenses the laser light and the measurement light, a first mirror that changes incident positions of the laser light and the measurement light on the lens, a second mirror that changes an incident position of the measurement light on the first mirror, a controller that controls an operation of the second mirror, and a measurement processing section that derives a depth of a keyhole based on the optical interference signal.

### BACKGROUND

### 1. Technical Field

The present disclosure relates to a laser processing device.

### 2. Description of the Related Art

Unexamined Japanese Patent Publication No. 2020-185601 discloses a laser processing device that measures a depth of a keyhole generated during metal processing with laser light by using an optical coherence tomography (OCT) technique for visualizing an internal structure of a sample with an optical interferometer.

### SUMMARY

It may be desired to simultaneously perform laser processing on a plurality of locations of the workpiece depending on a shape of a workpiece or the like.

However, since there is usually only one OCT light for measuring the depth of the keyhole, there is a problem that depths of a plurality of keyholes cannot be measured.

The present disclosure has been made in view of such a point, and an object of the present disclosure is to enable measurement of a depth of a keyhole generated at a processing point in a case where laser processing is simultaneously performed on a plurality of locations of a workpiece.

A laser processing device according to the present disclosure is a laser processing device that emits laser light to a predetermined processing point on a surface of a workpiece. The processing point includes at least a first processing point and a second processing point separated from the first processing point. The laser processing device includes a laser oscillator that oscillates the laser light, a first branching unit that branches the laser light into first laser light emitted to the first processing point and second laser light emitted to the second processing point, an optical interferometer that emits measurement light having a wavelength different from a wavelength of the laser light, and generates an optical interference signal based on the measurement light reflected by the processing point, a lens that condenses the laser light and the measurement light, a first mirror that changes incident positions of the laser light and the measurement light on the lens, a second mirror that changes an incident position of the measurement light on the first mirror, a controller that controls an operation of the second mirror such that the measurement light is emitted to the first processing point and the second processing point, and a measurement processing section that derives a depth of a keyhole generated at the processing point based on the optical interference signal.

According to the present disclosure, it is possible to measure the depth of the keyhole generated at the processing point in a case where the laser processing is simultaneously performed on the plurality of locations of the workpiece.

### BRIEF DESCRIPTION OF THE DRAWINGS

FIG. 1 is a diagram illustrating a configuration of a laser processing device according to a first exemplary embodiment;

FIG. 2 is a diagram illustrating a configuration of a laser processing device according to a second exemplary embodiment;

FIG. 3 is a diagram illustrating a configuration of a laser processing device according to a third exemplary embodiment;

FIG. 4 is a diagram illustrating a configuration of a laser processing device according to a fourth exemplary embodiment;

FIG. 5 is a plan view illustrating a state where measurement light is scanned between a first processing point and a second processing point;

FIG. 6 is a plan view illustrating a state where measurement light is scanned planarly between the first processing point and the second processing point;

FIG. 7 is a diagram illustrating a configuration of a laser processing device according to a fifth exemplary embodiment;

FIG. 8 is a diagram illustrating a configuration of a laser processing device according to a sixth exemplary embodiment;

FIG. 9 is a diagram illustrating a configuration of a laser processing device according to a seventh exemplary embodiment; and

FIG. 10 is a perspective view illustrating a configuration of a rotary electric motor.

### DETAILED DESCRIPTIONS

Hereinafter, exemplary embodiments of the present disclosure will be described with reference to the drawings. Incidentally, the present disclosure is not limited to the following exemplary embodiments. In addition, in order to clarify the description, the following description and drawings are simplified as appropriate.

### First Exemplary Embodiment

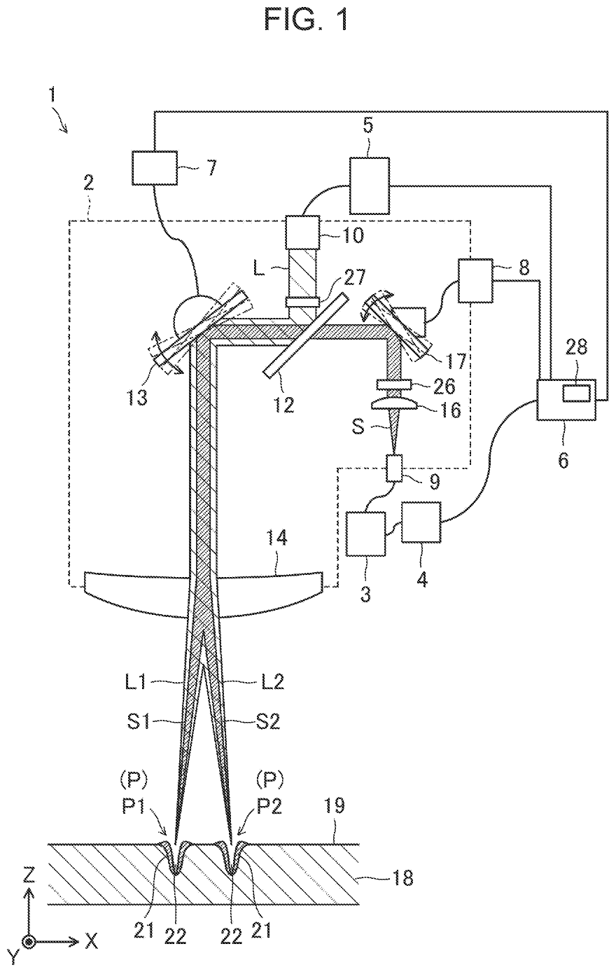

As illustrated in FIG. 1, laser processing device 1 includes processing head 2, optical interferometer 3, measurement processing section 4, laser oscillator 5, and controller 6.

Optical interferometer 3 emits measurement light S for OCT measurement. Measurement light S is input from measurement light introduction port 9 to processing head 2.

Laser oscillator 5 oscillates laser light L for processing. Laser light L is input from processing light introduction port 10 to processing head 2.
processing head 2 includes dichroic mirror 12, first mirror 13, lens 14, and second mirror 17.

A wavelength of laser light L and a wavelength of measurement light S are different wavelengths. Dichroic mirror 12 has a characteristic of reflecting light having the wavelength of laser light L and transmitting light having the wavelength of measurement light S.

First mirror 13 and second mirror 17 are movable mirrors that can be rotated in two or more axes. In the present exemplary embodiment, each of first mirror 13 and second mirror 17 is formed by using a galvanometer mirror.

First mirror 13 changes incident positions of laser light L and measurement light S on lens 14. Second mirror 17 changes an incident position of measurement light S on first mirror 13.

First mirror 13 is connected to controller 6 via first driver 7. Second mirror 17 is connected to controller 6 via second driver 8. First mirror 13 and second mirror 17 operate based on the control of controller 6. Controller 6 controls an operation of second mirror 17 such that measurement light S is emitted toward processing point P.

Memory 28 is built in controller 6. Memory 28 stores processing data for performing desired processing on workpiece 18 and correction data for performing correction. An example of controller 6 is a processor that controls first driver 7 and second driver 8. Controller 6 can control operations of first mirror 13 and second mirror 17 by controlling first driver 7 and second driver 8.

The example illustrated in FIG. 1 illustrates only rotation operations of first mirror 13 and second mirror 17 about rotation axes perpendicular to a paper surface as indicated by virtual lines. However, in practice, first mirror 13 and second mirror 17 are configured to be rotatable about two or more axes as described above, and can perform, for example, rotation operations about rotation axes parallel to the paper surface.

In the following description, for the sake of simplicity, although a case where first mirror 13 and second mirror 17 perform only the rotation operations about the rotation axes perpendicular to the paper surface will be described as illustrated in FIG. 1, the present disclosure is not limited thereto, and first mirror 13 and second mirror 17 can also perform rotation operations about another rotation axes.

Lens 14 is a lens for condensing laser light L and measurement light S at processing point P. Lens 14 is, for example, an fθ lens.

Laser light L introduced from processing light introduction port 10 is branched by first branching unit 27. Laser light L is branched into first laser light L1 and second laser light L2.

Note that, in the present exemplary embodiment, although a diffraction grating is used as first branching unit 27, the present disclosure is not limited to this embodiment, and for example, a prism lens or a beam splitter may be used.

Thereafter, laser light L branched by first branching unit 27 is reflected by dichroic mirror 12 and first mirror 13, transmitted through lens 14, and condensed on processing point P on surface 19 of workpiece 18.

As a result, processing point P of workpiece 18 is laser-processed. At this time, processing point P irradiated with laser light L is melted to form molten pool 21. In addition, molten metal is evaporated from molten pool 21, and keyhole 22 is formed by a pressure of steam generated during evaporation.

Processing point P includes first processing point P1 and second processing point P2 separated from first processing point P1. First laser light L1 is emitted to first processing point P1. Second laser light L2 is emitted to second processing point P2.

Measurement light S introduced from measurement light introduction port 9 is brought into a state close to parallel light by collimator lens 16. Measurement light S transmitted through collimator lens 16 is branched by second branching unit 26. Measurement light S is branched into first measurement light S1 and second measurement light S2.

Note that, in the present exemplary embodiment, although a diffraction grating is used as second branching unit 26, the present disclosure is not limited to this embodiment, and for example, a prism lens or a beam splitter may be used.

Measurement light S branched by second branching unit 26 is reflected by second mirror 17 and then transmitted through dichroic mirror 12. Measurement light S transmitted through dichroic mirror 12 is reflected by first mirror 13, transmitted through lens 14, and condensed on processing point P on surface 19 of workpiece 18.

Measurement light S is reflected by a bottom surface of keyhole 22, moves back along a propagation path of measurement light S, and reaches optical interferometer 3. Optical interferometer 3 generates an optical interference signal based on interference caused by an optical path difference between measurement light S reflected at processing point P and reference light (not illustrated).

Measurement processing section 4 derives a depth of keyhole 22 generated at processing point P, that is, a penetration depth of processing point P based on the optical interference signal. Note that, the penetration depth means a distance between an uppermost point of a melted portion of workpiece 18 and surface 19 of workpiece 18. Measurement processing section 4 includes, for example, a light balance detector including a photodetector and a computer including a processor.

First mirror 13 and lens 14 constitute a general optical scanning system including a galvanometer mirror and an fθ lens. Thus, an arrival position of laser light L on surface 19 of workpiece 18 can be controlled by rotating first mirror 13 from an origin position by a predetermined operation amount.

Note that, the operation amount of first mirror 13 for irradiating desired processing point P with laser light L can be uniquely set as long as optical members constituting processing head 2, a positional relationship therebetween, and a distance from lens 14 to surface 19 of workpiece 18 are determined.

The distance from lens 14 to surface 19 of workpiece 18 is preferably disposed such that a focal position where laser light L is most condensed and surface 19 of workpiece 18 coincide with each other, and processing with laser light L is most efficiently performed. However, the present exemplary embodiment is not limited to this embodiment, and the distance from lens 14 to surface 19 of workpiece 18 may be determined to be any distance in accordance with a processing application.

An operation angle (operation amount) of first mirror 13 is changed according to a predetermined operation schedule, and thus, a position of processing point P can be scanned on surface 19 of workpiece 18. Furthermore, laser oscillator 5 is switched between on or off or an output thereof is changed under the control of controller 6. Thus, laser processing can be performed on any position on surface 19 of workpiece 18 within a scannable range of laser light L in any pattern.

In addition, second branching unit 26 is disposed on an optical axis of measurement light S. As a result, similarly to laser light L, measurement light S is also transmitted through lens 14 and then branched into first measurement light S1 and second measurement light S2.

Second mirror 17 is operated by a predetermined operation angle (operation amount), and thus, measurement light S can be controlled to reach processing point P. Memory 28 stores an operation amount for correcting and canceling an aberration of lens 14 and deviations in an irradiation position of laser light L and measurement light S on surface 19 of workpiece 18 by first branching unit 27 or the like. Controller 6 moves first mirror 13 and second mirror 17 based on the operation amount stored in memory 28.

As described above, according to laser processing device 1 according to the present exemplary embodiment, it is possible to correct deviations in an arrival position of laser light L and measurement light S on surface 19 of workpiece 18. Thus, in a case where welding is performed at a plurality of locations simultaneously, weld depths of the locations can be measured.

### Second Exemplary Embodiment

Hereinafter, the same reference numerals will be given to the same parts as the parts in the first exemplary embodiment, and only differences will be described.

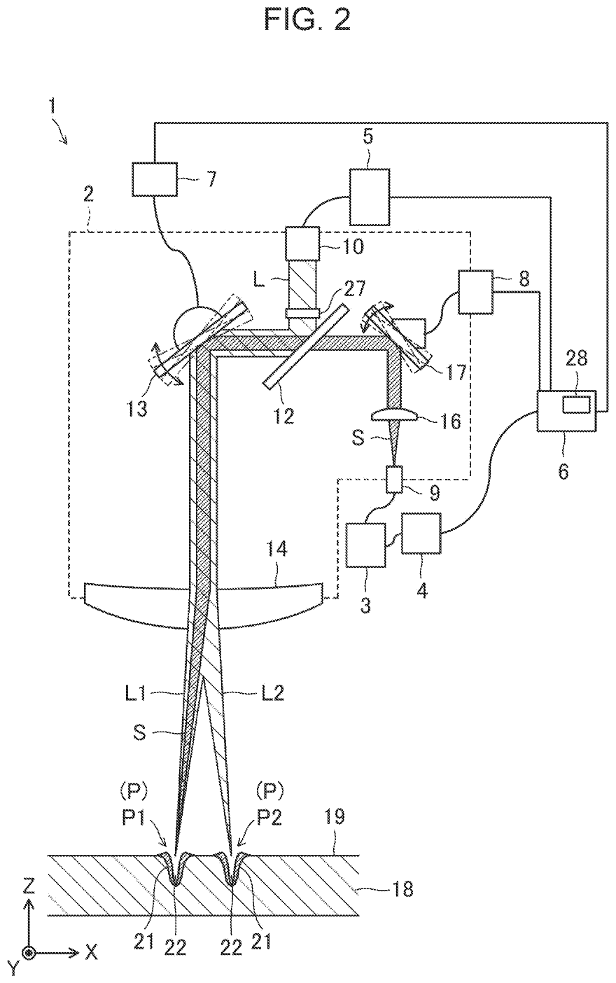

As illustrated in FIG. 2, laser processing device 1 includes processing head 2, optical interferometer 3, measurement processing section 4, laser oscillator 5, and controller 6.

Laser light L introduced from processing light introduction port 10 is branched by first branching unit 27. Laser light L is branched into first laser light L1 and second laser light L2.

Thereafter, laser light L branched by first branching unit 27 is reflected by dichroic mirror 12 and first mirror 13, transmitted through lens 14, and condensed on processing point P on surface 19 of workpiece 18.

Measurement light S introduced from measurement light introduction port 9 is brought into a state close to parallel light by collimator lens 16. Measurement light S transmitted through collimator lens 16 is reflected by second mirror 17 and then transmitted through dichroic mirror 12. Measurement light S transmitted through dichroic mirror 12 is reflected by first mirror 13, transmitted through lens 14, and condensed on processing point P on surface 19 of workpiece 18.

Here, laser light L is branched into first laser light L1 and second laser light L2 by first branching unit 27. Processing point P of workpiece 18 includes first processing point P1 at which first laser light L1 is emitted and second processing point P2 at which second laser light L2 is emitted. On the other hand, measurement light S is not branched.

Controller 6 operates second mirror 17 by a predetermined operation angle (operation amount) to perform a first measurement operation of emitting measurement light S to first processing point P1 or a second measurement operation of emitting measurement light S to second processing point P2. In the example illustrated in FIG. 2, measurement light S is emitted to first processing point P1.

Measurement processing section 4 derives a depth of keyhole 22 at first processing point P1. In the present exemplary embodiment, a depth of keyhole 22 at second processing point P2 is not measured, and is estimated to be the same as the depth of keyhole 22 at first processing point P1.

### Third Exemplary Embodiment

Hereinafter, the same reference numerals will be given to the same parts as the parts in the second exemplary embodiment, and only differences will be described.

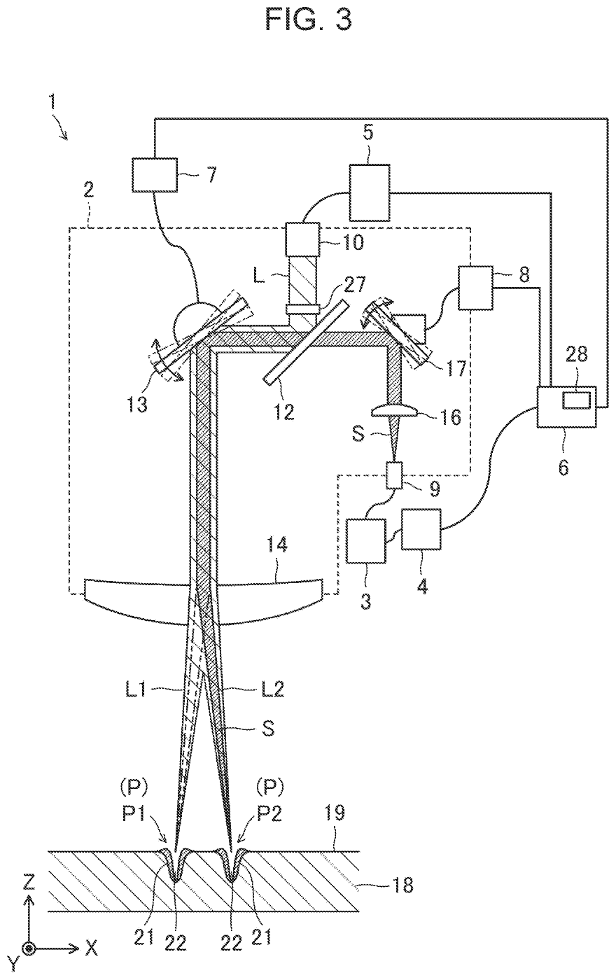

As illustrated in FIG. 3, laser light L is branched into first laser light L1 and second laser light L2 by first branching unit 27. Processing point P of workpiece 18 includes first processing point P1 at which first laser light L1 is emitted and second processing point P2 at which second laser light L2 is emitted. On the other hand, measurement light S is not branched.

Controller 6 controls an operation of second mirror 17 to alternately perform a first measurement operation of emitting measurement light S to first processing point P1 and a second measurement operation of emitting measurement light S to second processing point P2.

That is, in the present exemplary embodiment, an emission position of measurement light S is switched between a position where measurement light S is emitted to first processing point P1 (indicated by a virtual line in FIG. 3) and a position where measurement light S is emitted to second processing point P2 (indicated by a solid line in FIG. 3), and a depth of keyhole 22 at first processing point P1 and a depth of keyhole 22 at second processing point P2 are measured by causing the emission position to sequentially coincide with processing point P to be measured.

### Fourth Exemplary Embodiment

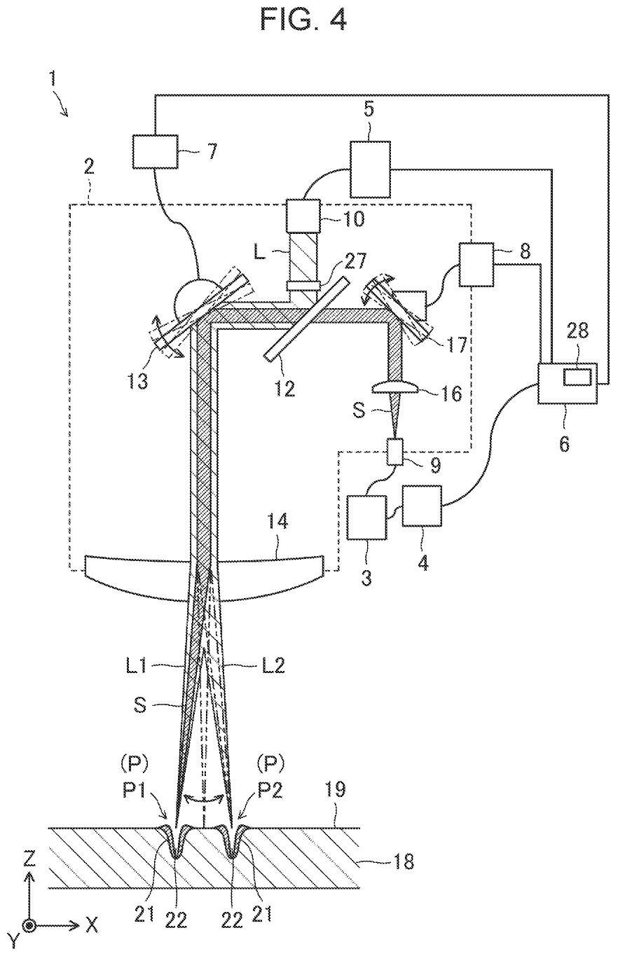

As illustrated in FIG. 4, laser light L is branched into first laser light L1 and second laser light L2 by first branching unit 27. Processing point P of workpiece 18 includes first processing point P1 at which first laser light L1 is emitted and second processing point P2 at which second laser light L2 is emitted. On the other hand, measurement light S is not branched.

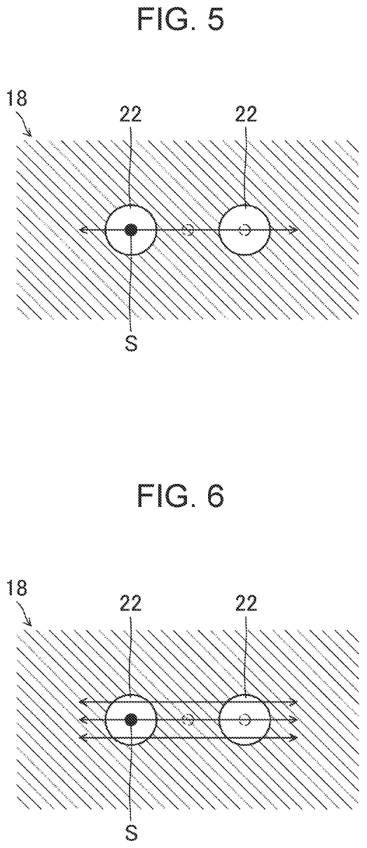

Controller 6 controls an operation of second mirror 17 to continuously emit measurement light S between first processing point P1 and second processing point P2. Specifically, as illustrated in FIG. 5, measurement light S is scanned to reciprocate between first processing point P1 and second processing point P2.

Measurement processing section 4 derives depths of keyholes 22 at first processing point P1 and second processing point P2 and a height of surface 19 of workpiece 18 based on an optical interference signal.

As a result, in a case where welding is performed at a plurality of locations simultaneously, weld depths of the locations can be measured. In addition, information on a peripheral portion of processing point P can also be obtained.

Note that, as illustrated in FIG. 6, when measurement light S is scanned by reciprocating between first processing point P1 and second processing point P2, measurement light S may be reciprocated while being shifted also in a direction orthogonal to a reciprocating direction. As a result, peripheral portions of first processing point P1 and second processing point P2 can be scanned in a planar manner, and more pieces of information can be obtained about the peripheral portion of processing point P.

### Fifth Exemplary Embodiment

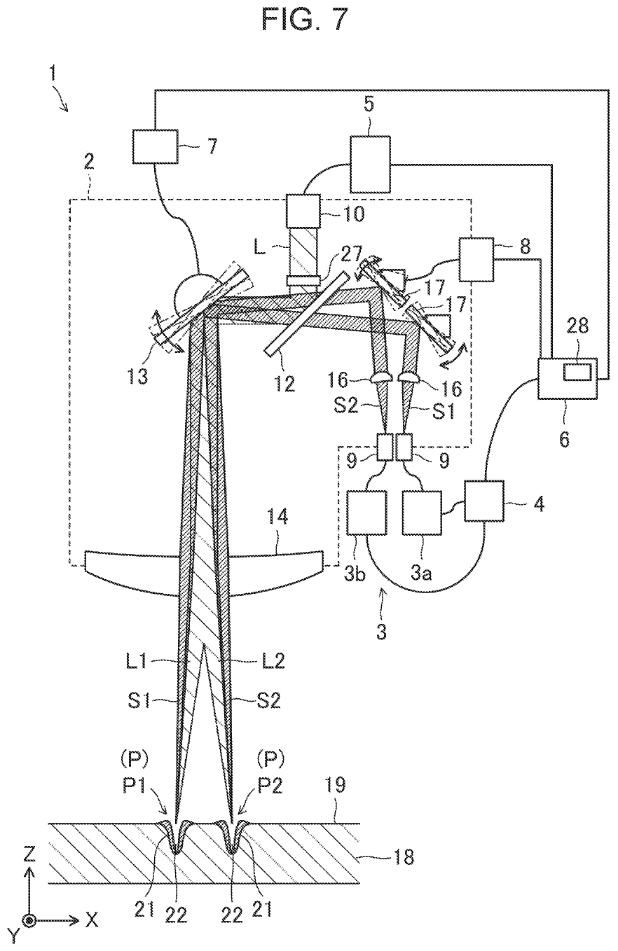

As illustrated in FIG. 7, laser processing device 1 includes processing head 2, two optical interferometers 3, measurement processing section 4, laser oscillator 5, and controller 6. Optical interferometer 3 includes first optical interferometer 3a and second optical interferometer 3b.

Processing head 2 includes dichroic mirror 12, first mirror 13, two second mirrors 17, and lens 14.

Laser light L introduced from processing light introduction port 10 is branched by first branching unit 27. Laser light L is branched into first laser light L1 and second laser light L2.

Thereafter, laser light L branched by first branching unit 27 is reflected by dichroic mirror 12 and first mirror 13, transmitted through lens 14, and condensed on processing point P on surface 19 of workpiece 18.

First optical interferometer 3a emits first measurement light S1. First measurement light S1 introduced from measurement light introduction port 9 is brought into a state close to parallel light by collimator lens 16. First measurement light S1 transmitted through collimator lens 16 is reflected by second mirror 17. At this time, second mirror 17 is operated by a predetermined operation angle (operation amount), and thus, first measurement light S1 can be controlled to reach first processing point P1.

Second optical interferometer 3b emits second measurement light S2. Second measurement light S2 introduced from measurement light introduction port 9 is brought into a state close to parallel light by collimator lens 16. Second measurement light S2 transmitted through collimator lens 16 is reflected by second mirror 17. At this time, second mirror 17 is operated by a predetermined operation angle (operation amount), and thus, second measurement light S2 can be controlled to reach second processing point P2.

With such a configuration, in a case where welding is performed at a plurality of locations simultaneously, weld depths of the locations can be measured. In addition, first measurement light S1 and second measurement light S2 can be emitted following first processing point P1 and second processing point P2.

Note that, in the exemplary embodiment described above, although second mirror 17 that is a galvanometer mirror is used to change optical axis directions of first measurement light S1 and second measurement light S2, the present disclosure is not limited thereto. For example, the optical axis direction of first measurement light S1 and the optical axis direction of second measurement light S2 may be changed based on the control of controller 6 by being installed between measurement light introduction port 9 and dichroic mirror 12.

### Sixth Exemplary Embodiment

In the explanation below, the same reference numerals will be given to the parts that are the same as those in the fifth exemplary embodiment, and only differences will be explained.

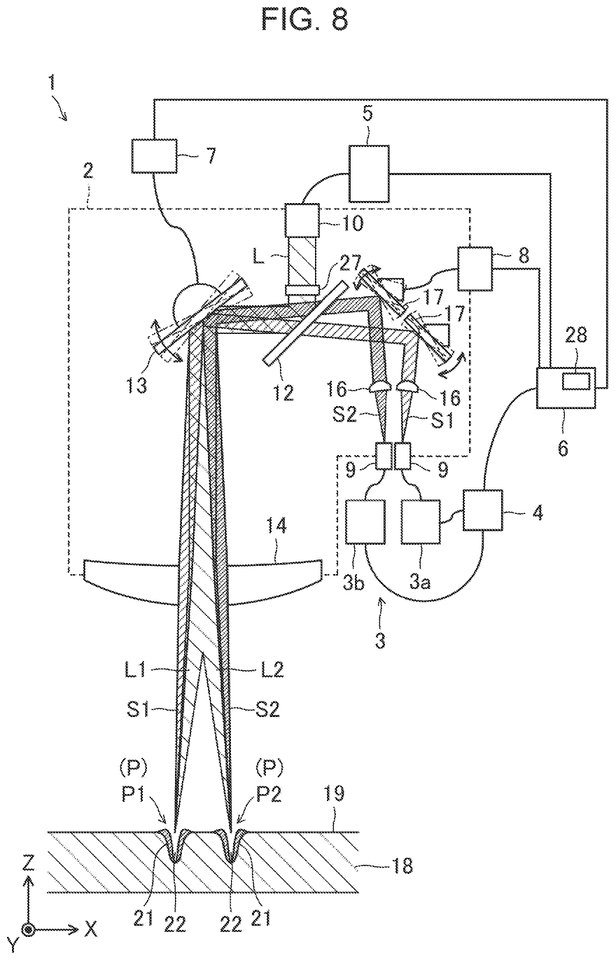

As illustrated in FIG. 8, laser processing device 1 includes a processing head 2, two optical interferometers 3, a measurement processing section 4, a laser oscillator 5, and a controller 6. Optical interferometer 3 includes first optical interferometer 3a and second optical interferometer 3b.

Here, the wavelength of first measurement light S1 emitted from the first optical interferometer 3a is different from the wavelength of second measurement light S2 emitted from the second optical interferometer 3b.

In this way, by setting first measurement light S1 and second measurement light S2 to have different wavelengths, first measurement light S1 and second measurement light S2 are not mixed, and erroneous detection can be prevented.

### Seventh Exemplary Embodiment

In the above-described exemplary embodiment, laser welding is simultaneously performed on a plurality of locations of one workpiece 18, but for example, laser welding may be simultaneously performed on two workpieces 18 to join workpieces 18 to each other.

Hereinafter, the same reference numerals will be given to the same parts as the parts in the first exemplary embodiment, and only differences will be described.

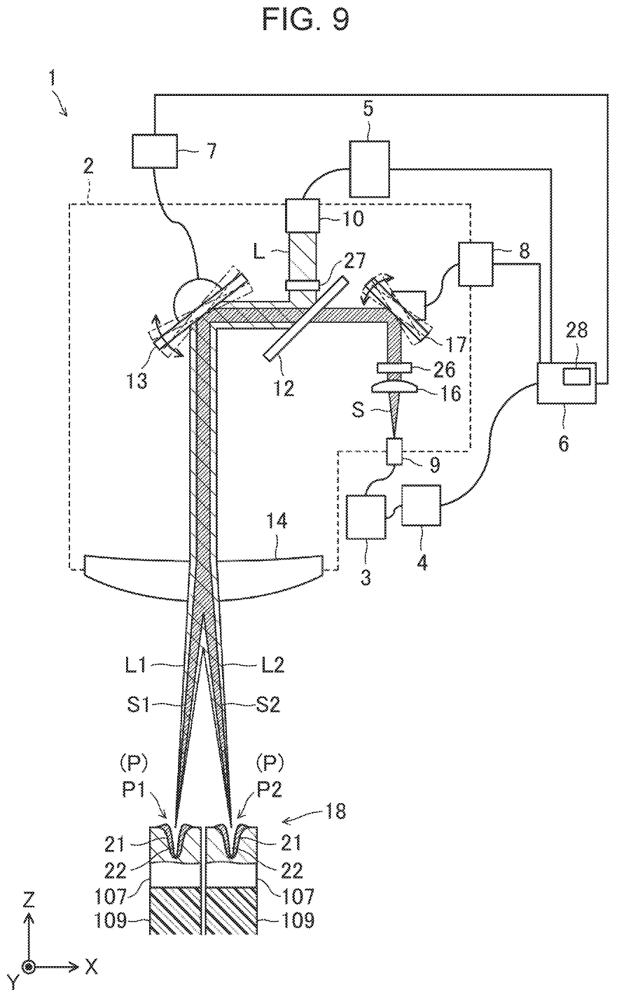

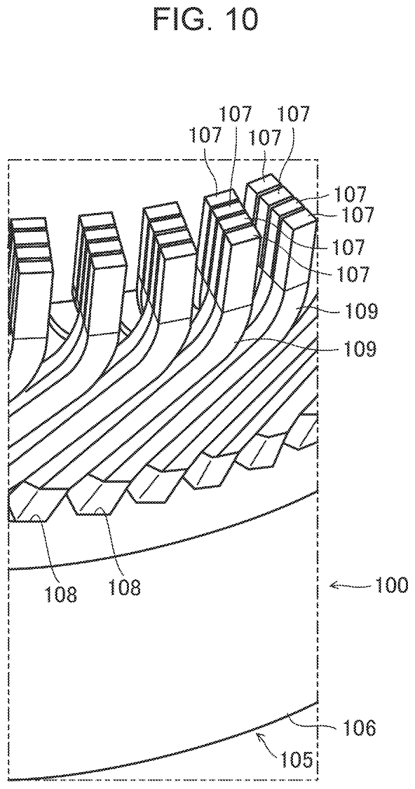

As illustrated in FIG. 9, laser processing device 1 emits first laser light L1 and second laser light L2 to coils 107 (see FIG. 10) of stator 105 of rotary electric motor 100 as workpiece 18.

End portions of two coils 107 are joined to each other by laser welding. Laser processing device 1 manufactures rotary electric motor 100 by performing laser welding on two coils 107. Rotary electric motor 100 of the present exemplary embodiment can be applied to, for example, a motor for driving a vehicle, a generator, and the like.

As illustrated in FIG. 10, rotary electric motor 100 includes stator 105 and a rotor (not illustrated). Stator 105 includes stator core 106 and coils 107. Stator core 106 is formed in a cylindrical shape. The rotor is disposed inside stator core 106. A plurality of slots 108 are provided in stator core 106. Slots 108 extend in an axial direction along a central axis of stator core 106. The plurality of slots 108 are provided at equal intervals in a circumferential direction around the central axis of stator core 106.

Coil 107 is inserted into slot 108. Coils 107 are formed by bundling, for example, a plurality of electric conductors made of copper. Two coils 107 are disposed to be adjacent to each other. The end portion of coil 107 protrudes from slot 108.

Usually, although covering portion 109 made of resin or the like is present on the entire surface of coil 107, covering portion 109 at the end portion of coil 107 is removed during laser welding.

As illustrated in FIG. 9, laser processing device 1 emits first laser light L1 to first processing point P1 of one coil 107 of two coils 107. In addition, laser processing device 1 emits second laser light L2 to second processing point P2 of other coil 107. As a result, two coils 107 can be melted and joined to each other.

As described above, the present disclosure can be applied to a laser processing device that performs processing of automobiles, electronic components, rotary electric motors, and the like using keyhole welding such as electron beam processing and laser processing.

What is claimed is:

1. A laser processing device that emits laser light to a predetermined processing point on a surface of a workpiece, the processing point including a first processing point and a second processing point separated from the first processing point, the laser processing device comprising:
a laser oscillator that oscillates the laser light;
a first branching unit that branches the laser light into first laser light emitted to the first processing point and second laser light emitted to the second processing point;
an optical interferometer that emits measurement light having a wavelength different from a wavelength of the laser light, and generates an optical interference signal based on the measurement light reflected by the processing point;
a lens that condenses the laser light and the measurement light;
a first mirror that changes incident positions of the laser light and the measurement light on the lens;
a second mirror that changes an incident position of the measurement light on the first mirror;
a controller that controls an operation of the second mirror such that the measurement light is emitted to the processing point; and
a measurement processing section that derives a depth of a keyhole generated at the processing point based on the optical interference signal.

2. The laser processing device according to claim 1, wherein the controller controls the operation of the second mirror such that a first measurement operation of emitting the measurement light to the first processing point and a second measurement operation of emitting the measurement light to the second processing point are performed.

3. The laser processing device according to claim 1, wherein the controller controls the operation of the second mirror such that a first measurement operation of emitting the measurement light to the first processing point and a second measurement operation of emitting the measurement light to the second processing point are alternately performed.

4. The laser processing device according to claim 1, wherein the controller controls the operation of the second mirror such that the measurement light is continuously emitted between the first processing point and the second processing point.

5. The laser processing device according to claim 4, wherein the measurement processing section further drives a height of the surface of the workpiece based on the optical interference signal.

6. The laser processing device according to claim 1, further comprising a second branching unit that branches the measurement light into first measurement light emitted to the first processing point and second measurement light emitted to the second processing point.

7. The laser processing device according to claim 1, wherein
the measurement light includes:
first measurement light emitted to the first processing point, and
second measurement light emitted to the second processing point, and
the optical interferometer includes:
a first optical interferometer that emits the first measurement light, and
a second optical interferometer that emits the second measurement light.

8. The laser processing device according to claim 7, wherein a wavelength of the first measurement light is different from a wavelength of the second measurement light.

9. The laser processing device according to claim 1, wherein the workpiece is a coil of a stator of a rotary electric motor.
